(19) United States
(12) Patent Application Publication
(10) Pub. No.: US 2012/0281574 A1
(43) Pub. Date: Nov. 8, 2012

(54) METHOD OF SYNCHRONISATION CHANNEL (SCH) INTERFERENCE CANCELLATION IN A MOBILE COMMUNICATION SYSTEM

(75) Inventors: Duong Pham, Victoria (AU); Hangdong Xue, Victoria (AU); Maciej Domanski, Victoria (AU); Xinhua Wang, Victoria (AU)

(73) Assignee: NEC Corporation

(21) Appl. No.: 13/503,603

(22) PCT Filed: Oct. 25, 2010
(86) PCT No.: PCT/JP2010/069246

§ 371 Date: Jul. 20, 2012

(30) Foreign Application Priority Data
Oct. 28, 2009 (AU) 2009905286

(51) Int. Cl. H04B 15/00; H04W 24/02

(52) U.S. Cl. 370/252

(57) ABSTRACT

A method of SCH interference cancellation in a mobile communication system, including the steps of: (a) receiving a chip equalised signal on one or more streams, each signal having a CPICH and a plurality of chips in one or more slots; (b) generating a PSC pattern and an SSC pattern for a P-SCH and an S-SCH associated with the signal; (c) estimating the power of P-SCH and S-SCH; (d) estimating a power ratio for each of the P-SCH to CPICH and the S-SCH to CPICH; (e) SCH interference cancelling in the first 256 chips of the n-th slot.

### TECHNICAL FIELD

The present invention relates generally to wireless communication systems having a plurality of transmitters and user equipment, and in particular to the SCH signals transmitted for the purposes of synchronisation between user equipment (UE) and one or more base stations.

### BACKGROUND ART

In mobile communication systems, SCH signals are transmitted during the first 256 chips of slots for the purpose of synchronisation between user-equipment and the base-station. Synchronisation channels are provided and include a Primary Synchronization Channel (Primary SCH) which is coded with a Primary Synchronization Code (PSC). The purpose of the PSC is to provide slot timing. A secondary Synchronization Channel (Secondary SCH) is also provided which is coded with Secondary Synchronization Codes (SSC). The same primary synchronisation codes (PSC) are transmitted in all slots. Different secondary synchronisation codes (SSC) are transmitted in different slots of a radio frame.

A problem with the SCH signals is that they are not orthogonal with other signals. Thus they interfere with other signals and need to be removed when demodulating the other signals. Otherwise, the throughput of the system will be reduced significantly.

It would be desirable to provide a method of synchronisation channel (SCH) interference cancellation in a mobile communication system that ameliorates or overcomes one or more disadvantages or inconveniences of existing systems.

### SUMMARY

With this in mind, one aspect of the present invention provides a method of SCH interference cancellation in a mobile communication system, including the steps of: (a) receiving a chip equalised signal on one or more streams, each signal having a CPICH and a plurality of chips in one or more slots; (b) generating a PSC pattern and an SSC pattern for a P-SCH and an S-SCH associated with the signal; (c) estimating the power of P-SCH and S-SCH; (d) estimating a power ratio for each of the P-SCH to CPICH and the S-SCH to CPICH; (e) SCH interference cancelling in the first 256 chips of the n-th slot.

Preferably, the P-SCH pattern is generated by: generating a modulator X.; concatenating 1 and −1 to generate a sequence a=[1, 1, 1, 1, 1, 1, −1, −1,1, −1,1, −1,1, −1, −1,1]; concatenating a and −a to generate a sequence A=[a, a, a, −a, −a, a, −a, −a, a, a, a, −a, a, −a,a,a]; multiplying the modulator λ with complex value (1+j) and sequence A.

The P-SCH pattern may be given by the expression:

c_{P-SCH}=λ×(1+j)×A=λ×(1+j)×[a,a,a,−a,−a,a,−a,−a,a,a,a,−a,a,−a,a,a].

Preferably, the S-SCH pattern is generated by: generating a modulator λ; concatenating 1 and −1 to generate a sequence a=[1, 1, 1, 1, 1, 1, −1, −1,1, −1, 1, 4, 1, −1, −1, 1]; generating from the elements of a, a sequence b=[α(1), α(2), α(3), α(4), α(5), α(6), α(7), α(8), −α(9), −α(10), −α(11), −α(12), −α(13), −α(14), −α(15), −α(16)] concatenating the sequence b and the sequence −b to generate a sequence z=[b, b, b, −b, b, b, −b, −b, b, −b, b, −b, −b, −b, −b, −b] generating a Hadamard matrix H₈; generating the sequence: Zₖ=[hₘ(0)×z(0), hₘ(1), . . . , hₘ(255)×z(255)], k=1,2, . . . , 16 where sequence hₘ is the m-th row of the Hadamard matrix H₈, m=16×(k−1); multiplying the modulator λ with the complex value (1+j) and with the 16 sequences Zₖ to generate the 16 sequences c_{SSC,k}=λ×(1+j)×Zₖ=λ×(1+j)×[hₘ(0)×z(0), hₘ(1)×z(1), . . . , hₘ(255)×z(255)], k=1,2, . . . ,16 selecting a set of 15 S-SCH patterns c_{SSC,k} for 15 slots associated with 1 of 64 scrambling code groups from a predetermined table; and selecting the S-SCH pattern for the n-th slot, c_{S-SCH,n}, as the n-th sequence in the set, i.e. c_{S-SCH,n}=c_{SSC,k}.

Preferably, H₈ is given by the expression:

$${H}_{0} = [ 1 ]$$

$${H}_{1} = [ \begin{matrix}{H}_{0} & {H}_{0} \\ {H}_{0} & - {H}_{0}\end{matrix} ]$$

$${H}_{k} = [ \begin{matrix}{H}_{k - 1} & {H}_{k - 1} \\ {H}_{k - 1} & - {H}_{k - 1}\end{matrix} ] , k \geq 1$$

Preferably, the modulator λ=1 if the Primary Common Control Physical Channel (P-CCPCH) of the signal is Space Time Transmit Diversity (STTD) encoded.

Alternatively, the modulator λ=−1 if the Primary Common Control Physical Channel (P-CCPCH) of the signal is not Space Time Transmit Diversity (STTD) encoded.

Preferably, at step (d) the P-SCH to CPICH and S-SCH to CPICH power ratio is determined by: multiplying the chip equaliser output signal by the conjugate of the P-SCH pattern for the first 256 chips of each slot; summing the multiplications; dividing the summed multiplications by the power of an average of the CPICH symbols for that slot; averaging the result over N consecutive slots.

The P-SCH to CPICH power ratio may be given by the expression:

$${R}_{P - SCH} = \frac{1}{N} {\sum }_{n = {n}_{0}}^{{n}_{0} + N - 1} ( \vert {\sum }_{i = 0}^{255} {x}_{n} ( i ) \times {c}_{P - SCH}^{*} ( i ) \vert / {\vert \frac{1}{8} {\sum }_{i = 0}^{7} {f}_{n} ( i ) \vert}^{2} )$$

The P-SCH to CPICH power ratio may be given by the expression:

$${R}_{S - SCH} = \frac{1}{N} {\sum }_{n = {n}_{0}}^{{n}_{0} + N - 1} ( \vert {\sum }_{i = 0}^{255} {x}_{n} ( i ) \times {c}_{S - SCH , n}^{*} ( i ) \vert / {\vert \frac{1}{8} {\sum }_{i = 0}^{7} {f}_{n} ( i ) \vert}^{2} )$$

Preferably at step (c) estimation of SCH power is determined by: estimating the CPICH power; estimating the P-SCH signal power and the S-SCH signal power.

Preferably, the CPICH power is estimated by: averaging the CPICH signals within a slot and for a number of slots; calculating the power of the averaged signal.

Preferably, estimating the P-SCH signal power and the S-SCH signal power is determined by multiplying the estimated CPICH power with P-SCH-CPICH power ratio and with S-SCH-CPICH power ratio, respectively.

Preferably, the ratio is determined by the expression:

P_{P-SCH,n}=R_{P-SCH}×P_{CPICH,n}

P_{S-SCH,n}=R_{S-SCH}×CPICH,n.

Preferably, at step (e) cancelling interference caused by the SCH includes the steps of: subtracting the P-SCH pattern scaled by the squared root of P-SCH power and subtracting the S-SCH pattern scaled by the squared root of S-SCH power from the received signal. As the received signal is a combination of the other signal and the SCH signal, this cancelling action results in the other signal only (without SCH signal).

Preferably, the SCH interference cancellation is given by the expression

yₙ(i)=xₙ(i)−\sqrt{P_{P-SCH,n}}=c_{P-SCH}(i)−\sqrt{P_{S-SCH,n}}×c_{S-SCH,n}(i), =0, . . . , 255

### BRIEF DESCRIPTION OF THE DRAWINGS

FIG. 1 is a schematic diagram illustrating the operation of SCH cancellers for two MIMO streams according to the method of the invention;

FIG. 2 is a schematic diagram of the SCH canceller of FIG. 1, illustrating the detailed operation of the SCH canceller component according to the method of the invention;

FIG. 3 is a schematic diagram of a P-SCH to CPICH power ratio per slot calculation according to the method of the invention;

FIG. 4 is a schematic diagram of a S-SCH to CPICH power ratio per slot calculation according to the method of the invention;

FIG. 5 is a schematic diagram of a CPICH power calculation according to the method of the invention; and

FIG. 6 is a flow chart showing steps involved in the method of the invention.

Embodiments of the invention will now be described, by way of example only, with reference to the accompanying drawings. It is to be understood that the particularity of the drawings and embodiments does not supersede the generality of the preceding description of the invention.

### EXEMPLARY EMBODIMENT

In WCDMA, SCH signals are transmitted during the first 256 chips of slots for the purpose of synchronization between user-equipment and the base-station. The same Primary Synchronization Codes (PSC) are transmitted in all slots. Different Secondary Synchronization Codes (SSC) are transmitted in different slots of a radio frame. The SCH signals are usually transmitted from antenna-1 (there may be more than 1 transmit antenna but SCH is always transmitted from the first antenna).

In the case of a Time Switched Transmit Diversity (TSTD), the SCH signals are transmitted from antenna-1 and antenna-2 alternatively.

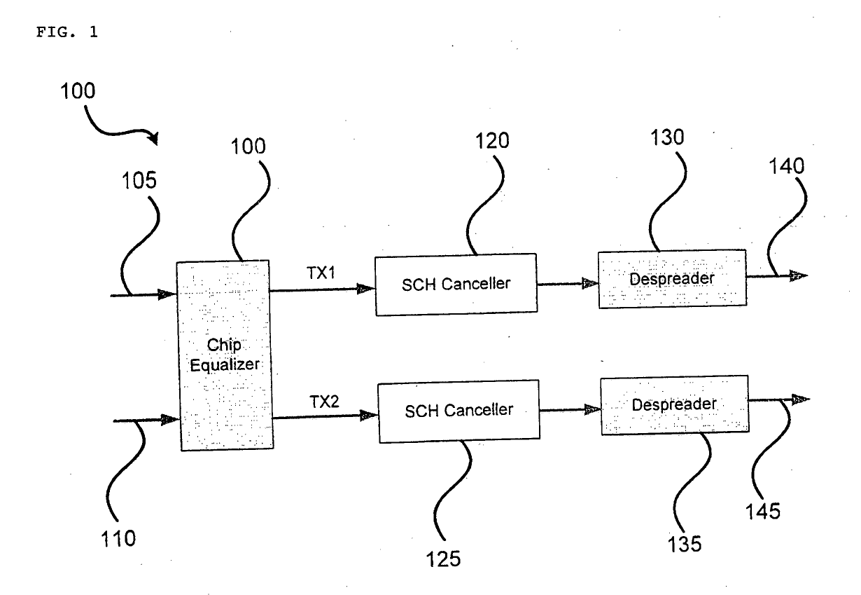

FIG. 1 shows an example of SCH cancellers 100 for two MIMO (Multiple Input Multiple Output) streams 105, 110. Also shown is a chip equalizer 115, SCH canceller component 120 and 125 for each of MIMO streams 105 and 110 respectively. Further, there is a de-spreader 130 and 135 for each of MIMO streams 105 and 110. The outputs of the de-spreader 130 and 135 are the despreaded signals received from transmit antenna 1 and transmit antenna 2, respectively, after SCH cancellation.

When the channelisation codes of two signals are orthogonal, the two signals will not interfere with each other after despreading. A problem with the SCH signals is that they are not orthogonal with other signals. Thus, they are interfering with other signals and need to be removed when demodulating the other signals. The chip equalizer 115 receives the MIMO streams 105, 110 as input and once equalized, outputs to the SCH canceller 120, 125 a chip equalizer output.

The chip equalizer output at the n-th slots of the MIMO signal can be written as follows:

xₙ(i)=\sqrt{P_{P-SCH ,n}}×c_{P-SCH}(i)+\sqrt{P_{S-SCH ,n}}×c_{S-SCH ,n}(i)+d(i)+w(), i=, . . . ,255

Where c_{P-SCH}, c_{P-SCH} an H_{P-SCH ,n} P_{S-SCH,n} C and their powers respectively; d denotes the other signals and W denotes noise.

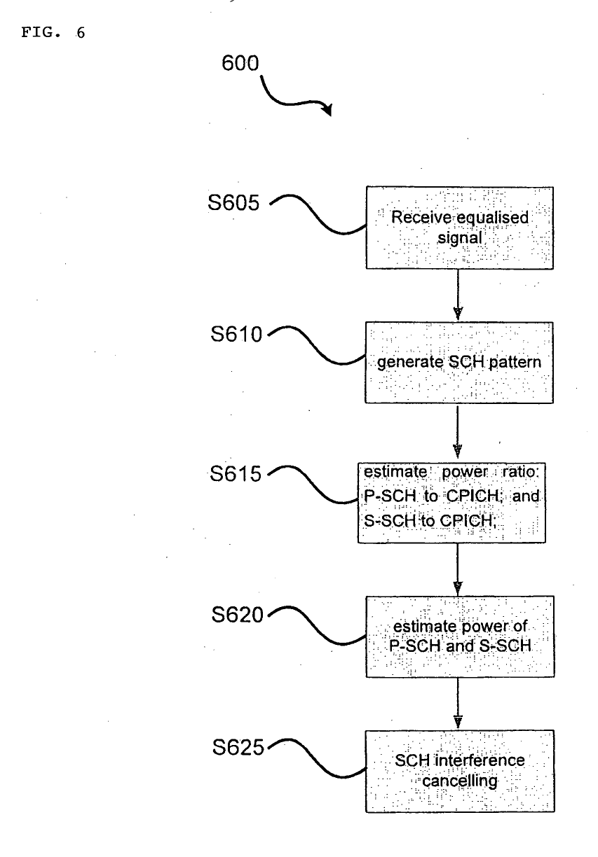

The present invention presents a method for cancellation of the PSC and SSC from the equalized signals, i.e. removal of \sqrt{P_{P-SCH,n}}×c_{P-SCF}(i\sqrt{P_{S-SCH,n}}×c_{S-SCH,n}(i) from xₙ(i). On the assumption that the SCH to CPICH power ratio is fixed for a period of time (if not all the time), the method involves: Generation of the P-SCH and S-SCH patterns c_{P-SCH} and c_{S-SCH ,n}, estimation of the SCH powers P_{P-SCH,n} and P_{S-SCH ,n} which involve estimation of SCH to CPICH power ratio, and subtraction of \sqrt{P_{P-SCH ,n}}×c_{P-SCH}(i) and \sqrt{P_{S-SCH ,n}}(i) from xₙ(i) as will be further described with reference to FIG. 6.

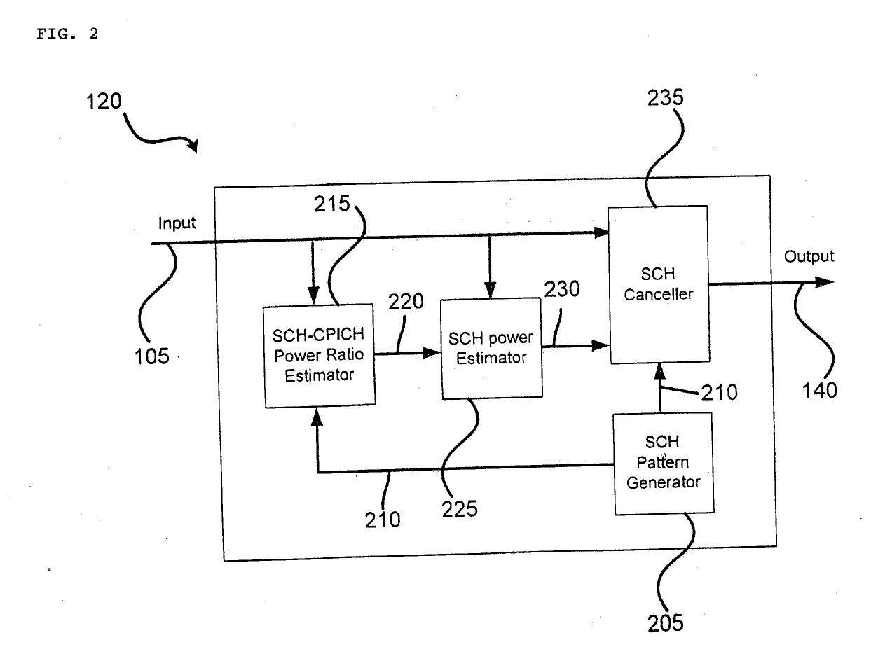

The SCH canceller component 120, 125 cancels the PSC and SSC from the equalized signals and will further be described in detail with reference to FIG. 2. The output of the SCH canceller components 120 and 125 feed into de-spreader 130 and 135. De-spreader 130 and 135 are used to correlate the received signal in chips with the corresponding channelisation code so that the desired signal can be recovered at symbol level and the undesired signals are suppressed by a factor of spreading gain. The output of the de-spreader 140, 145 goes to a demodulation block in order to convert the received signal from “symbols” into “bits”.

FIG. 2 is a block diagram which further illustrates the operation of the SCH canceller component 120 of FIG. 1, but for simplicity only one stream 105 is shown. The SCH canceller component 120 includes a number of modules including a SCH pattern generator 205, a SCH-CPICH power ratio estimator 215, an SCH power estimator 225 and an SCH canceller module 235.

The SCH canceller 120 receives as input a stream 105 and provides as output 140 once processed a stream which has the PSC and SSC cancelled from the equalized signal. The stream 105 is received as input to SCH-CPICH power ratio estimator 215, SCH power estimator 225 and SCH canceller module 235. An SCH pattern generator 205 generates output signals 210 which go to the SCH-CPICH power ratio estimator 215 and the SCH canceller module 235. The SCH-CPICH power ratio estimator 215 receives the output from the SCH pattern generator 210 and the input stream 105 to produce an output 220 which is fed into the SCH power estimator 225. The SCH power estimator 225 also receives the stream 105 as input together with the output from the SCH-CPICH power ratio estimator to provide an output 230 to the SCH canceller module 235. The SCH canceller module 235 receives the MIMO stream 105 as input together with the output from the SCH power estimator 230 and the SCH pattern generator 210 to provide an output 140 which is a stream which has the PSC and SSC cancelled from the equalized signal. The method will be further described with reference to FIG. 6.

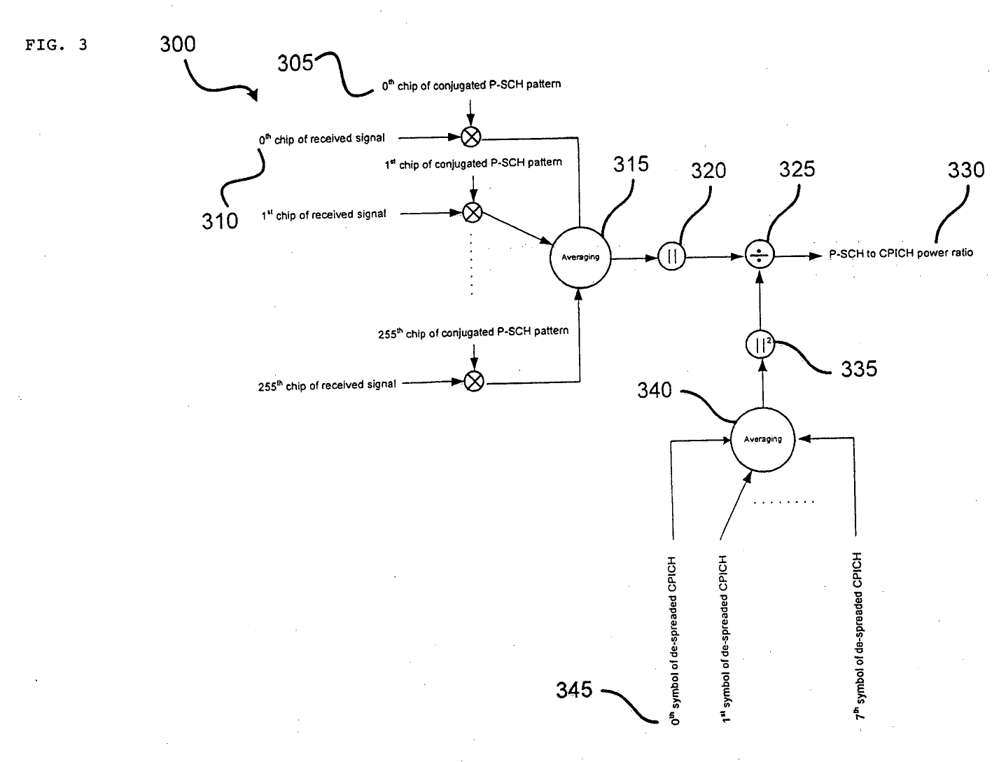

FIG. 3 shows a schematic 300 of a power ratio per slot calculation for P-SCH to CPICH. Each of the first 256 chips of the conjugated P-SCH pattern 305 and the received signal 310 are summed and then averaged at averaging component 315. The output of averaging component 315 is fed into component 320 where the absolute value is determined. The output of component 320 is fed into divided-by operator 325. Further, the 8 symbols of the de-spreaded CIPCH 345 are averaged at averaging component 340 and the output of averaging component 340 is fed into component 335 which calculates the signal power (absolute value and then squared). The output of component 335 is fed into dividing component 325 which then provides the output 330 which is the P-SCH to CPICH power ratio. This method will be further described with reference to FIG. 6.

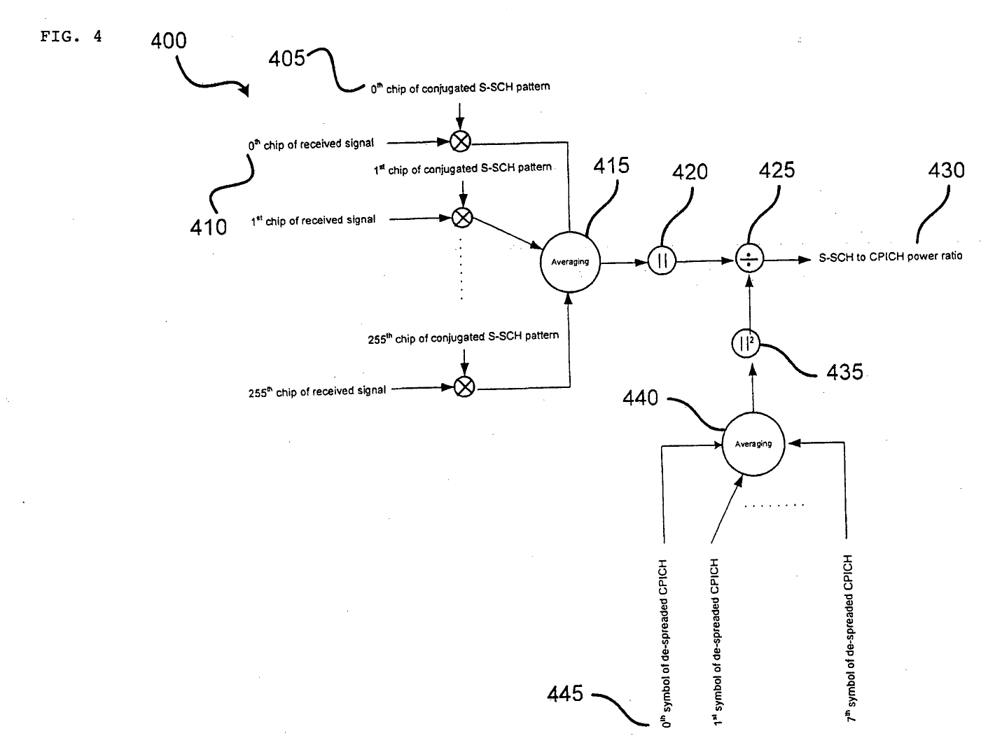

FIG. 4 shows a block diagram of the calculation for the S-SCH to CPICH power ratio per slot calculation 400. Each of the first 256 chips of the conjugated S-SCH pattern 405 and the received signal 410 are summed and then averaged at averaging component 415. The output of averaging component 415 is fed into component 420 which determines the absolute value. The output of component 420 is fed into divided-by operator 425. Further, the 8 symbols of the de-spreaded CIPCH 445 are averaged at averaging component 440 and the output of averaging component 440 is fed into component 435 where the signal power is calculated (absolute value and then squared). The output of component 435 is fed into dividing component 425 which then provides the output 430 which is the S-SCH to CPICH power ratio. This method will be further described with reference to FIG. 6.

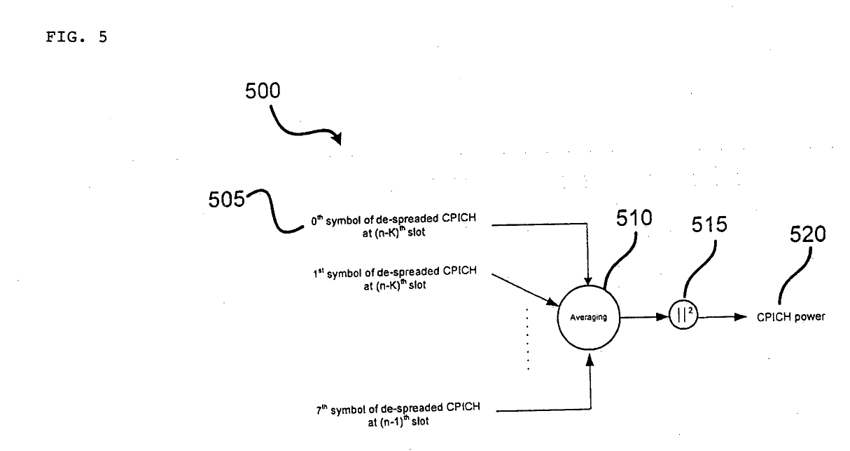

FIG. 5 shows a block diagram of a calculation of the CPICH power 500 where eight symbols of the de-spreaded CPICH are received as input 505 at the n-Kth slot. If the cancellation happens at the n-th slot then the C-PICH power calculation is done before that i.e. the CPICH power calculation is carried out during previous K slots. The output of the de-spreaded CPICH 505 is averaged as averaging component 510 and the output of the averaging component 510 is fed into component 515 which calculates the signal power (absolute value and then square). The output of component 515 is the CPICH power 520.

FIG. 6 shows the method 600 carried out by each of the modules described in FIG. 2 for SCH interference cancellation. At step 605 a chip equalizer signal is received on one or more streams with each signal having a CPICH and the plurality of chips in one or more slots such as via MIMO stream 105, 110 as shown in FIG. 1. Control then moves to step 610 where a PSC pattern and an SSC pattern is generated for a P-SCH and an S-SCH associated with the input signal. The P-SCH pattern is generated by: generating a modulator λ; concatenating 1 and −1 to generate a sequence a=[1, 1, 1, 1, 1, 1, −1, −1, 1, −1, 1, −1, 1, −1, −1, 1]; concatenating a and −a to generate a sequence A=[a, a, a, −a, −a, a, −a, −a, a, a, a, −a, a, −a, a, a]; multiplying the modulator λ with complex value (1+j) and sequence A.

The P-SCH pattern is given by the expression:

c_{P-SCH}=λ×(1+j)×A=×(1+j)×[a, a, a, −a, −a, a, −a, −a, a, a, a, −a, a, −a, a, a]

The S-SCH pattern is generated by: generating a modulator X; concatenating 1 and −1 to generate a sequence a=[1, 1, 1, 1, 1, 1, −1, −1, 1, −1, 1, −1, 1, −1, −1, 1]; generating from the elements of a, a sequence b=[α(1), α(2), α(3), α(4), α(5), α(6), α(7), α(8), −α(9), −α(10), −α(11), −α(12), −α(13), −α(14), −α(15), −α(16)] concatenating the sequence b and the sequence −b to generate a sequence z=[b, b, b, −b, b, b, −b, −b, b, −b, b, −b, −b, −b, −b, −b]; generating a Hadamard matrix H₈; generating the sequence: Zₖ=hₘ(0)×z(0), hₘ(1)×z(1), . . . , hₘ(255)×z(255)k=1,2, . . . ,16 where sequence hₘ is the m-th row of the Hadamard matrix H₈, m=16×k; In this generation, the i-th element of Zₖ, namely Zₖ(i), is the product of the i-th element of hₘ, namely hₘ(i), and the i-th element of z, namely z(i).

The modulator λ is then multiplied with the complex value (1+j) and with the 16 sequences Zₖ to generate the 16 sequences c_{SSC,k}=λ×(1+j)×Zₖ=λ×(1+j)×[hₘ(0)×z(0), hₘ(1)×z(1), . . . , hₘ(255)×z(255)], k=1,2, . . . ,16 .

A set of 15 S-SCH patterns c_{SSC ,k} is then selected for 15 slots associated with 1 of 64 scrambling code groups from a predetermined table such as Table 1 (below); selecting the S-SCH pattern for the n-th slot, c_{S-SCH ,n} as the n-th sequence in the set, i.e. c_{S-SCH ,n}=c_{SSC ,k}. For example: the pattern for slot −0 of the code group 0 is c_{S-SCH ,0}=c_{SSC ,1}.

The hadamard matrix may be given by the expression:

$${H}_{0} = [ 1 ]$$

$${H}_{1} = [ \begin{matrix}{H}_{0} & {H}_{0} \\ {H}_{0} & - {H}_{0}\end{matrix} ]$$

$${H}_{k} = [ \begin{matrix}{H}_{k - 1} & {H}_{k - 1} \\ {H}_{k - 1} & - {H}_{k - 1}\end{matrix} ] , k \geq 1.$$

A set of 15 S-SCH patterns for 15 slots is selected to be associated with one of 64 scrambling code groups as shown in table 1 below.

TABLE 1
Allocation of SSCs for S-SCH

| Scrambling | slot number | | | | | | | | | | | | | | |
|---|---|---|---|---|---|---|---|---|---|---|---|---|---|---|---|
| Code Group | #0 | #1 | #2 | #3 | #4 | #5 | #6 | #7 | #8 | #9 | #10 | #11 | #12 | #13 | #14 |
| Group 0 | 1 | 1 | 2 | 8 | 9 | 10 | 15 | 8 | 10 | 16 | 2 | 7 | 15 | 7 | 16 |
| Group 1 | 1 | 1 | 5 | 16 | 7 | 3 | 14 | 16 | 3 | 10 | 5 | 12 | 14 | 12 | 10 |
| Group 2 | 1 | 2 | 1 | 15 | 5 | 5 | 12 | 16 | 6 | 11 | 2 | 16 | 11 | 15 | 12 |
| Group 3 | 1 | 2 | 3 | 1 | 8 | 6 | 5 | 2 | 5 | 8 | 4 | 4 | 6 | 3 | 7 |
| Group 4 | 1 | 2 | 16 | 6 | 6 | 11 | 15 | 5 | 12 | 1 | 15 | 12 | 16 | 11 | 2 |
| Group 5 | 1 | 3 | 4 | 7 | 4 | 1 | 5 | 5 | 3 | 6 | 2 | 8 | 7 | 6 | 8 |
| Group 6 | 1 | 4 | 11 | 3 | 4 | 10 | 9 | 2 | 11 | 2 | 10 | 12 | 12 | 9 | 3 |
| Group 7 | 1 | 5 | 6 | 6 | 14 | 9 | 10 | 2 | 13 | 9 | 2 | 5 | 14 | 1 | 13 |
| Group 8 | 1 | 6 | 10 | 10 | 4 | 11 | 7 | 13 | 16 | 11 | 13 | 6 | 4 | 1 | 16 |
| Group 9 | 1 | 6 | 13 | 2 | 14 | 2 | 6 | 5 | 5 | 13 | 10 | 9 | 1 | 14 | 10 |
| Group 10 | 1 | 7 | 8 | 5 | 7 | 2 | 4 | 3 | 8 | 3 | 2 | 6 | 6 | 4 | 5 |
| Group 11 | 1 | 7 | 10 | 9 | 16 | 7 | 9 | 15 | 1 | 8 | 16 | 8 | 15 | 2 | 2 |
| Group 12 | 1 | 8 | 12 | 9 | 9 | 4 | 13 | 16 | 5 | 1 | 13 | 5 | 12 | 4 | 8 |
| Group 13 | 1 | 8 | 14 | 10 | 14 | 1 | 15 | 15 | 8 | 5 | 11 | 4 | 10 | 5 | 4 |
| Group 14 | 1 | 9 | 2 | 15 | 15 | 16 | 10 | 7 | 8 | 1 | 10 | 8 | 2 | 16 | 9 |
| Group 15 | 1 | 9 | 15 | 6 | 16 | 2 | 13 | 14 | 10 | 11 | 7 | 4 | 5 | 12 | 3 |
| Group 16 | 1 | 10 | 9 | 11 | 15 | 7 | 6 | 4 | 16 | 5 | 2 | 12 | 13 | 3 | 14 |
| Group 17 | 1 | 11 | 14 | 4 | 13 | 2 | 9 | 10 | 12 | 16 | 8 | 5 | 3 | 15 | 6 |
| Group 18 | 1 | 12 | 12 | 13 | 14 | 7 | 2 | 8 | 14 | 2 | 1 | 13 | 11 | 8 | 11 |
| Group 19 | 1 | 12 | 15 | 5 | 4 | 14 | 3 | 16 | 7 | 8 | 6 | 2 | 10 | 11 | 13 |
| Group 20 | 1 | 15 | 4 | 3 | 7 | 6 | 10 | 13 | 12 | 5 | 14 | 16 | 8 | 2 | 11 |
| Group 21 | 1 | 16 | 3 | 12 | 11 | 9 | 13 | 5 | 8 | 2 | 14 | 7 | 4 | 10 | 15 |
| Group 22 | 2 | 2 | 5 | 10 | 16 | 11 | 3 | 10 | 11 | 8 | 5 | 13 | 3 | 13 | 8 |
| Group 23 | 2 | 2 | 12 | 3 | 15 | 5 | 8 | 3 | 5 | 14 | 12 | 9 | 8 | 9 | 14 |
| Group 24 | 2 | 3 | 6 | 16 | 12 | 16 | 3 | 13 | 13 | 6 | 7 | 9 | 2 | 12 | 7 |
| Group 25 | 2 | 3 | 8 | 2 | 9 | 15 | 14 | 3 | 14 | 9 | 5 | 5 | 15 | 8 | 12 |
| Group 26 | 2 | 4 | 7 | 9 | 5 | 4 | 9 | 11 | 2 | 14 | 5 | 14 | 11 | 16 | 16 |
| Group 27 | 2 | 4 | 13 | 12 | 12 | 7 | 15 | 10 | 5 | 2 | 15 | 5 | 13 | 7 | 4 |
| Group 28 | 2 | 5 | 9 | 9 | 3 | 12 | 8 | 14 | 15 | 12 | 14 | 5 | 3 | 2 | 15 |
| Group 29 | 2 | 5 | 11 | 7 | 2 | 11 | 9 | 4 | 16 | 7 | 16 | 9 | 14 | 14 | 4 |
| Group 30 | 2 | 6 | 2 | 13 | 3 | 3 | 12 | 9 | 7 | 16 | 6 | 9 | 16 | 13 | 12 |
| Group 31 | 2 | 6 | 9 | 7 | 7 | 16 | 13 | 3 | 12 | 2 | 13 | 12 | 9 | 16 | 6 |
| Group 32 | 2 | 7 | 12 | 15 | 2 | 12 | 4 | 10 | 13 | 15 | 13 | 4 | 5 | 5 | 10 |
| Group 33 | 2 | 7 | 14 | 16 | 5 | 9 | 2 | 9 | 16 | 11 | 11 | 5 | 7 | 4 | 14 |
| Group 34 | 2 | 8 | 5 | 12 | 5 | 2 | 14 | 14 | 8 | 15 | 3 | 9 | 12 | 15 | 9 |
| Group 35 | 2 | 9 | 13 | 4 | 2 | 13 | 8 | 11 | 6 | 4 | 6 | 8 | 15 | 15 | 11 |
| Group 36 | 2 | 10 | 3 | 2 | 13 | 16 | 8 | 10 | 8 | 13 | 11 | 11 | 16 | 3 | 5 |
| Group 37 | 2 | 11 | 15 | 3 | 11 | 6 | 14 | 10 | 15 | 10 | 6 | 7 | 7 | 14 | 3 |
| Group 38 | 2 | 16 | 4 | 5 | 16 | 14 | 7 | 11 | 4 | 11 | 14 | 9 | 9 | 7 | 5 |
| Group 39 | 3 | 3 | 4 | 6 | 11 | 12 | 13 | 6 | 12 | 14 | 4 | 5 | 13 | 5 | 14 |
| Group 40 | 3 | 3 | 6 | 5 | 16 | 9 | 15 | 5 | 9 | 10 | 6 | 4 | 15 | 4 | 10 |
| Group 41 | 3 | 4 | 5 | 14 | 4 | 6 | 12 | 13 | 5 | 13 | 6 | 11 | 11 | 12 | 14 |
| Group 42 | 3 | 4 | 9 | 16 | 10 | 4 | 16 | 15 | 3 | 5 | 10 | 5 | 15 | 6 | 6 |
| Group 43 | 3 | 4 | 16 | 10 | 5 | 10 | 4 | 9 | 9 | 16 | 15 | 6 | 3 | 5 | 15 |
| Group 44 | 3 | 5 | 12 | 11 | 14 | 5 | 11 | 13 | 3 | 6 | 14 | 6 | 13 | 4 | 4 |
| Group 45 | 3 | 6 | 4 | 10 | 6 | 5 | 9 | 15 | 4 | 15 | 5 | 16 | 16 | 9 | 10 |
| Group 46 | 3 | 7 | 8 | 8 | 16 | 11 | 12 | 4 | 15 | 11 | 4 | 7 | 16 | 3 | 15 |
| Group 47 | 3 | 7 | 16 | 11 | 4 | 15 | 3 | 15 | 11 | 12 | 12 | 4 | 7 | 8 | 16 |
| Group 48 | 3 | 8 | 7 | 15 | 4 | 8 | 15 | 12 | 3 | 16 | 4 | 16 | 12 | 11 | 11 |
| Group 49 | 3 | 8 | 15 | 4 | 16 | 4 | 8 | 7 | 7 | 15 | 12 | 11 | 3 | 16 | 12 |
| Group 50 | 3 | 10 | 10 | 15 | 16 | 5 | 4 | 6 | 16 | 4 | 3 | 15 | 9 | 6 | 9 |
| Group 51 | 3 | 13 | 11 | 5 | 4 | 12 | 4 | 11 | 6 | 6 | 5 | 3 | 14 | 13 | 12 |
| Group 52 | 3 | 14 | 7 | 9 | 14 | 10 | 13 | 8 | 7 | 8 | 10 | 4 | 4 | 13 | 9 |
| Group 53 | 5 | 5 | 8 | 14 | 16 | 13 | 6 | 14 | 13 | 7 | 8 | 15 | 6 | 15 | 7 |
| Group 54 | 5 | 6 | 11 | 7 | 10 | 8 | 5 | 8 | 7 | 12 | 12 | 10 | 6 | 9 | 11 |
| Group 55 | 5 | 6 | 13 | 8 | 13 | 5 | 7 | 7 | 6 | 16 | 14 | 15 | 8 | 16 | 15 |
| Group 56 | 5 | 7 | 9 | 10 | 7 | 11 | 6 | 12 | 9 | 12 | 11 | 8 | 8 | 6 | 10 |
| Group 57 | 5 | 9 | 6 | 8 | 10 | 9 | 8 | 12 | 5 | 11 | 10 | 11 | 12 | 7 | 7 |
| Group 58 | 5 | 10 | 10 | 12 | 8 | 11 | 9 | 7 | 8 | 9 | 5 | 12 | 6 | 7 | 6 |
| Group 59 | 5 | 10 | 12 | 6 | 5 | 12 | 8 | 9 | 7 | 6 | 7 | 8 | 11 | 11 | 9 |
| Group 60 | 5 | 13 | 15 | 15 | 14 | 8 | 6 | 7 | 16 | 8 | 7 | 13 | 14 | 5 | 16 |
| Group 61 | 9 | 10 | 13 | 10 | 11 | 15 | 15 | 9 | 16 | 12 | 14 | 13 | 16 | 14 | 11 |
| Group 62 | 9 | 11 | 12 | 15 | 12 | 9 | 13 | 13 | 11 | 14 | 10 | 16 | 15 | 14 | 16 |
| Group 63 | 9 | 12 | 10 | 15 | 13 | 14 | 9 | 14 | 15 | 11 | 11 | 13 | 12 | 16 | 10 |

For example, the set associated with the scrambling code group 0 is:

slot number

| #0 | #1 | #2 | #3 | #4 | #5 | #6 | #7 | #8 | #9 | #10 | #11 | #12 | #13 | #14 |
|---|---|---|---|---|---|---|---|---|---|---|---|---|---|---|
| 1 | 1 | 2 | 8 | 9 | 10 | 15 | 8 | 10 | 16 | 2 | 7 | 15 | 7 | 16 |

Following the generation of the patterns for the P-SCH and S-SCH, control moves to step 615 where the P-SCH to CPICH power ratio and the S-SCH to CPICH power ratio are estimated.

Control then moves to step 620 where the power of the P-SCH and S-SCH is estimated.

As illustrated in FIGS. 3 and 4 above, the SCH-CPICH Power Ratio Estimation is calculated according to the following formula:

$${R}_{P - SCH} = \frac{1}{N} {\sum }_{n = {n}_{0}}^{{n}_{0} + N - 1} ( \vert {\sum }_{i = 0}^{255} {x}_{n} ( i ) \times {c}_{P - SCH}^{*} ( i ) \vert / {\vert \frac{1}{8} {\sum }_{i = 0}^{7} {f}_{n} ( i ) \vert}^{2} )$$

$${R}_{S - SCH} = \frac{1}{N} {\sum }_{n = {n}_{0}}^{{n}_{0} + N - 1} ( \vert {\sum }_{i = 0}^{255} {x}_{n} ( i ) \times {c}_{S - SCH , n}^{*} ( i ) \vert / {\vert \frac{1}{8} {\sum }_{i = 0}^{7} {f}_{n} ( i ) \vert}^{2} ) .$$

Where, fₙ(0), . . . , fₙ(7) denotes the de-spreaded CPICH symbols of the n-slot and xₙ is the vector containing the first 256 chips of the n-th slot input signal.

The number of slots N is found from testing and simulation. A typical value of N would be in the range of 4 to 20. During the time between n₀ and n₀+N, the

User Equipment (UE) can use some predetermined values R_{P-PSCH}=R₀, R_{S-PSCH}=R₁. After the time n₀+N, this estimation procedure should be turned off. The procedure should be turned on in one of the following cases:
UE is switched on,
UE handoff to new cell,
UE is in formed of CPICH power boosting.

Specifically, the P-SCH-CPICH power ratio is calculated as follows: for the first 256 chips of each slot, multiplying the chip equaliser output signal by the conjugate of the P-SCH pattern; summing the multiplications; dividing the summed multiplications by the power of an average of the CPICH symbols for that slot; and averaging the result over N consecutive slots as follows:

$${R}_{P - SCH} = \frac{1}{N} {\sum }_{n = {n}_{0}}^{{n}_{0} + N - 1} ( \vert {\sum }_{i = 0}^{255} {x}_{n} ( i ) \times {c}_{P - SCH}^{*} ( i ) \vert / {\vert \frac{1}{8} {\sum }_{i = 0}^{7} {f}_{n} ( i ) \vert}^{2} )$$

Specifically, the S-SCH-CPICH power ratio is calculated as follows: for the first 256 chips of each slot, multiplying the chip equaliser output signal by the conjugate of the S-SCH pattern; summing the multiplications; dividing the summed multiplications by the power of an average of the CPICH symbols for that slot; and averaging the result over N consecutive slots as follows:

$${R}_{S - SCH} = \frac{1}{N} {\sum }_{n = {n}_{0}}^{{n}_{0} + N - 1} ( \vert {\sum }_{i = 0}^{255} {x}_{n} ( i ) \times {c}_{S - SCH , n}^{*} ( i ) \vert / {\vert \frac{1}{8} {\sum }_{i = 0}^{7} {f}_{n} ( i ) \vert}^{2} )$$

Control then moves to step 625 where SCH interference cancellation is carried out on the first 256 chips of the end slot of the one or more streams. The SCH interference cancellation process depends on the SCH channel structure in TSTD or in non-TSTD; specifically: If non TSTD: SCH cancellers at Chip-equalizer outputs TX1-RX1 and TX1-RX2 operate in all slots and SCH cancellers at Chip-equalizer outputs TX2-RX1 and TX2-RX2 do not operate. If TSTD: SCH cancellers at Chip-equalizer outputs TX1-RX1 and TX1-RX2 operate in even slots and SCH cancellers at Chip-equalizer outputs TX2-RX1 and TX2-RX2 operate in odd slots.

Specifically, estimate the CPICH power by averaging the CPICH signals within a slot and for a number of slots and then calculate the power of the averaged signal. Then estimate the P-SCH signal power and the S-SCH signal power by multiplying the estimated CPICH power with P-SCH-CPICH power ratio and with S-SCH-CPICH power ratio, respectively.

P_{P-SCH ,n}=R_{P-SCH}×P_{CPICH ,n}

P_{S-SCH ,n}=R_{S-SCH}×P_{CPICH ,n}

Specifically, with regard to cancellation of SCH interferences, at an operating canceller, the first 256 chips of each slot are SCH interference cancelled as follows: Subtracting a chip by the P-SCH pattern scaled by the squared root of P-SCH power and subtracting the result of the step above by the S-SCH pattern scaled by the squared root of S-SCH power according to this expression:

yₙ(i)=xₙ(i)−\sqrt{P_{P-SCH ,n}}×c_{P-SCH}(i)−\sqrt{P_{S-SCH ,n}}×c_{S-SCH ,n}(i), i=0, . . . , 255

Advantageously SCH interference is estimated using autocorrelation of CPICH and autocorrelation of SCH which is more effective than using cross-correlation of SCH with the received signal.

The arrangement of the present invention can cope with the fact that PSCH and SSCH have different power settings instead of assuming that PSCH and SSCH have the same power. The arrangement of the present invention can cope with the semi-static power ratios between CPICH and PSCH and between CPICH and SSCH instead of fixed power ratios.

Advantageously SCH interference is cancelled at chip-level after chip equalization which is simpler to implement than at symbol level after de-spreading.

Advantageously, the estimated power ratios between CPICH and PSCH and between CPICH and SSCH are filtered to remove noise before being used in SCH cancellation. The filtering may be carried out by averaging over N consecutive slots as described above.

SCH interference is preferably cancelled at chip-level after the chip-equalizer, but can also be cancelled at symbol level after de-spreading if required. Depending on implementation cost cancelling at chip level is more suitable for the scenario where the number of channelisation codes to be demodulated is large, such as HSPA+ (Evolved High Speed Packet Access). Alternatively, cancelling at symbol level is better suited to the scenario where the number of channelisation codes to be demodulated is small, such as DCH (Dedicated Channel).

Advantageously estimating SCH power via CPICH power is easy to estimate because it involves estimating of the power ratio between CPICH and SCH as the mean, estimation of CPICH power and using autocorrelation of CPICH and autocorrelation of SCH to perform the estimation.

Future patent applications may be filed in Australia or overseas on the basis of or claiming priority from the present application. It is to be understood that the following provisional claims are provided by way of example only, and are not intended to limit the scope of what may be claimed in any such future application. Features may be added to or omitted from the provisional claims at a later date so as to further define or re-define the invention or inventions.

1. A method of SCH interference cancellation in a mobile communication system, including the steps of:
(a) receiving a chip equalised signal on one or more streams, each signal having a CPICH and a plurality of chips in one or more slots;
(b) generating a PSC pattern and an SSC pattern for a P-SCH and an S-SCH associated with the signal;
(c) estimating the power of P-SCH and S-SCH;
(d) estimating a power ratio for each of the P-SCH to CPICH and the S-SCH to CPICH;
(e) SCH interference cancelling in the first 256 chips of the n-th slot.

2. The method of claim 1, wherein the P-SCH pattern is generated by:
generating a modulator λ;
concatenating 1 and −1 to generate a sequence a=[1, 1, 1, 1, 1, 1, −1, −1, 1, −1, 1, −1, 1, −1, −1, 1]. concatenating a and −a to generate a sequence A=[a, a, a, −a, −a, a, −a, −a, a, a, a, −a, a, −a, a, a]. multiplying the modulator λ with complex value (1+j) and sequence A.

3. The method of claim 1, wherein the P-SCH pattern is given by the expression:
c_{P-SCH}=λ×(1+j)×A=λ×(1+j)×[a, a, a, −a, −a, a, −a, −a, a, a, a, −a, a, −a, a, a].

4. The method of claim 1, wherein the S-SCH pattern is generated by generating a modulator λ;
concatenating 1 and −1 to generate a sequence
a=[1, 1, 1, 1, 1, 1, −1, −1, 1, −1, 1, −1, 1, −1, −1],
generating from the elements of a, a sequence
b=[α(1), α(2), α(3), α(4), α(5), α(6), α(7), α(8), −α(9), −α(10), −α(11), −α(12), −α(13), −α(14), −α(15), −α(16)]
concatenating the sequence b and the sequence −b to generate a sequence z=[b, b, b, −b, b, b, −b, −b, b, −b, b, −b, −b, −b, −b, −b].
generating a Hadamard matrix H₈;
generating the sequence:
Zₖ=[hₘ(0)×z(0), hₘ(1)×z(1), . . . , hₘ(255)×z(255)], k=1,2, . . . ,16;
where sequence hₘ is the m-th row of the Hadamard matrix H₈m=16×k;
multiplying the modulator λ with the complex value (1+j) and with the 16 sequences Zₖ to generate the 16 sequences
c_{SSC,k}=λ×(1+j)×Zₖ=λ×(1+j)×[hₘ(0)×z(0), hₘ(1)×z(1), . . . , hₘ(255)×z(255)], k=1,2, . . . ,16
selecting a set of 15 S-SCH patterns c_{SSC,k} for 15 slots associated with 1 of 64 scrambling code groups from a predetermined table; and
selecting the S-SCH pattern for the n-th slot, c_{S-SCH ,n} as the n-th sequence in the set, i.e. c_{S-SCH ,n=c}_{SSC,k}.

5. The method of claim 1, wherein H₈ is given by the expression:
$${H}_{0} = [ 1 ]$$
$${H}_{1} = [ \begin{matrix}{H}_{0} & {H}_{0} \\ {H}_{0} & - {H}_{0}\end{matrix} ]$$
$${H}_{k} = [ \begin{matrix}{H}_{k - 1} & {H}_{k - 1} \\ {H}_{k - 1} & - {H}_{k - 1}\end{matrix} ] , k \geq 1.$$

6. The method of claim 1, wherein the modulator λ=1 if the Primary Common Control Physical Channel (P-CCPCH) of the signal is Space Time Transmit Diversity (STTD) encoded.

7. The method of claim 1, wherein the modulator λ=−1 if the Primary Common Control Physical Channel (P-CCPCH) of the signal is not Space Time Transmit Diversity (STTD) encoded.

8. The method of claim 1, wherein at step (d) the P-SCH to CPICH and S-SCH to CPICH power ratio is determined by:
multiplying the chip equaliser output signal by the conjugate of the P-SCH pattern for the first 256 chips of each slot;
summing the multiplications;
dividing the summed multiplications by the power of an average of the CPICH symbols for that slot;
averaging the result over N consecutive slots.

9. The method of claim 1, wherein the P-SCH to CPICH power ratio is given by the expression:
$${R}_{P - SCH} = \frac{1}{N} {\sum }_{n = {n}_{0}}^{{n}_{0} + N - 1} ( \vert {\sum }_{i = 0}^{255} {x}_{n} ( i ) \times {c}_{P - SCH}^{*} ( i ) \vert / {\vert \frac{1}{8} {\sum }_{i = 0}^{7} {f}_{n} ( i ) \vert}^{2} ) .$$

10. The method of claim 1, wherein the P-SCH to CPICH power ratio is given by the expression:
$${R}_{S - SCH} = \frac{1}{N} {\sum }_{n = {n}_{0}}^{{n}_{0} + N - 1} ( \vert {\sum }_{i = 0}^{255} {x}_{n} ( i ) \times {c}_{S - SCH , n}^{*} ( i ) \vert / {\vert \frac{1}{8} {\sum }_{i = 0}^{7} {f}_{n} ( i ) \vert}^{2} ) .$$

11. The method of claim 1, wherein at step (c) estimation of SCH power is determined by:
estimating the CPICH power;
estimating the P-SCH signal power and the S-SCH signal power.

12. The method of claim 1, wherein the CPICH power is estimated by:
averaging the CPICH signals within a slot and for a number of slots;
calculating the power of the averaged signal.

13. The method of claim 1, wherein estimating the P-SCH signal power and the S-SCH signal power is determined by multiplying the estimated CPICH power with P-SCH-CPICH power ratio and with P-SCH-CPICH power ratio, respectively.

14. The method of claim 12, wherein the ratio is determined by the expression:
P_{P-SCH ,n}=R_{P-SCH}×P_{CPICH ,n}
P_{S-SCH ,n}=R_{S-SCH}×P_{CPICH ,n}.

15. The method of claim 1, wherein at step (e) cancelling interference for the SCH includes the steps of:
subtracting the P-SCH pattern scaled by the squared root of P-SCH power to remove the P-SCH interference from the equalise chip sequence and subtracting the S-SCH pattern scaled by the squared root of S-SCH power to remove the S-SCH interference from the equalised chip sequence.

16. The method of claim 1, wherein the SCH interference cancellation is given by the expression
yₙ(i)=xₙ(i)−\sqrt{P_{P-SCH ,n}}×c_{P-SCH}⁽i)−\sqrt{P_{S-SCH ,n}}×c_{S-SCH ,n}(i), i=0, . . . ,255.
